(19) United States
(12) Patent Application Publication
(10) Pub. No.: US 2010/0005211 A1
(43) Pub. Date: Jan. 7, 2010

(54) ADAPTER BOARD ASSEMBLY

(75) Inventors: Po-Chih Wen, Chungho City (TW); Tzu-Ping Yu, Tungshan Hsiang (TW)

Correspondence Address: CHENBRO MICOM CO., LTD., PO BOX 108-00403, TAIPEI, TW

(73) Assignee: CHENBRO MICOM CO., LTD., Chung Ho City (TW)

(21) Appl. No.: 12/166,323

(22) Filed: Jul. 2, 2008

(51) Int. Cl. G06F 13/00; G06F 3/00

(52) U.S. Cl. 710/302; 710/301

(57) ABSTRACT

An adapter board assembly includes a board member installed in one slot of a motherboard of an electronic apparatus and having arranged thereon a plurality of electronic devices, signal input ports and signal output ports, a metal frame fixedly provided at one side of the board member for affixing the board member to a rack inside the electronic apparatus to stabilize the positioning of the board member, and a control circuit electrically connected with the signal input ports and the signal output ports for converting a first format of each external signal being inputted into one signal input port into a second format for output through one corresponding signal output port.

### BACKGROUND OF THE INVENTION

1. Field of the Invention

The present invention relates to an adapter board and more particularly, to an adapter board assembly for use in an electronic apparatus as an interface card for expansion purpose, which has easy mounting and dismounting characteristics, and which does not fall out of place upon accidental vibration, assuring transmission stability.

2. Description of the Related Art

Following fast development of high technology, the developing trend of computer and computer-based apparatus goes toward characteristics of small-size, powerful computing function and rapid operation speed. Raising computer performance efficiency is not simply relying upon the factor of increasing the operation speed of the central processing unit. The operation speed of the peripheral I/O interfaces shall also be relatively improved. An early ATA (Advanced Technology Attachment) serial bus runs at 133 MBs/sec. This speed cannot satisfy the speed requirement of a modern microprocessor. Therefore, STAT (Serial Advanced Technology Attachment) serial bus architecture that runs at 150 MBs/sec is developed.

SATA interface architecture not only improves signal transmission speed but also provides other advantages. When replacing a TAT peripheral apparatus, the host power must be turned off before the replacement. According to the data transmission line and power line arrangement of SATA interface architecture, the pin number and width of bus line of a SATA serial bus are relatively reduced, and the internal heat dissipation of the host is also improved. Further, the effective transmission range of a SATA serial bus is relatively longer than an ATA serial bus. Therefore, a SATA serial bus has a hot plug function.

Further, a regular USB (Universal Serial Bus) interface also has a hot plug function. When considering data transmission speed and power supply stability, a USB interface simply suitable for use in peripheral apparatus of low driving power and moderate transmission speed, such as card reader, printer, memory stick, network phone and network camera. Due to the limitation of transmission speed, a USB interface is not suitable for use with a mobile hard disk drive or CD-R driver. Nowadays, DVD driver has been becoming the market mainstream. The transmission speed of a USB interface cannot satisfy the requirement of a DVD driver. The lower driving power may cause instability of the system power supply, resulting in further data reading failure or peripheral apparatus damage.

Although SATA interface architecture shows superiority to ATA and USB interface architectures, it is so inferior as compared to SCSI (Small Computer System Interface) architecture. More particularly, when one disk damaged, a SCSI (Small Computer System Interface) RAID (Redundant Array of Independent Disks) system gives an indication on the real time and allows for hot plug replacement of the damaged disk without affecting data transmission and assuring normal functioning of the server without interruption. Following this development, SATAII interface architecture is created to substitute for SATA interface architecture, providing a transmission speed as high as 300 MBs/sec and improving buffer storage performance by means of NCQ (Native Command Queuing). SATAII interface architecture also improves enclosure management, such as: fan control, temperature control, new disk indication and failing disk indication, enabling the user to monitor disk operation status, and therefore the protection of data transmission and storage is enhanced. Further, backplane interconnect is introduced to match with port multiplier technique, allowing multiple hard disks to be connected to one same backplane port so that two hosts can share one same hard disk through a port selector. In this case, when one host failed, the other host keeps functioning, assuring normal working of the server. Further, it facilitates hot plugging of a hard disk, allowing replacement of the failing hard disk without interruption.

Therefore, a SATA interface is very suitable for a mobile peripheral apparatus. In view of the aforesaid many advantages, many manufacturers continuously create new SATA compatible expansion cards. The use of a SATA compatible expansion card has the advantages of: (1) The user can directly install a SATA compatible expansion card to connect an external electronic apparatus having a SATA interface without replacing the whole motherboard; (2) A SATA compatible expansion card can be connected to an electronic apparatus that has built therein a SATA interface, and can also provide extra SATA compatible insertion ports for external apparatus. Further, new chipsets with RAID function are commercially available, assuring data storage safety and high data transmission speed. Further, a SATAII interface can be upgraded to serial attachment SCSI, where the transmission speed of every communication port can reach 3 GBs/sec. Because SAS interface architecture and SATA II interface architecture support each other, an electronic device of SATA II interface design can be directly connected to an SAS interface for application, providing best flexibility and performance.

Currently, the operating frequency of the CPU of a host computer and its memory transmission bandwidth can reach 533 MBs/sec. Nowadays, many high-speed dual-core and multiple-core CPUs have been created. Simply providing one single SATA interface is insufficient to meet the operating speed of a high-speed dual-core and multiple-core CPU. Even a SATA II interface that runs at 300 MBs/sec, the data storage and reading speed can not satisfy the requirement to achieve optimal operation. Further, the number, type and connection method of the connection interfaces of a motherboard are predetermined in factory. A user cannot freely change the number, type and connection method of the connection interfaces of a commercial motherboard. Further, the connection interfaces of a motherboard are fixed devices. When one connection interface is damaged, all the connection interfaces must be detached for a replacement, wasting much maintenance labor and time and increasing the maintenance cost. When replacing the whole motherboard, the cost will be very high.

### SUMMARY OF THE INVENTION

The present invention has been accomplished under the circumstances in view. According to one aspect of the present invention, the adapter board assembly is used as an interface card in an electronic apparatus for system expansion, comprising a board member and a control circuit. The board member is a circuit board installed in one slot of the motherboard of the electronic apparatus, having arranged thereon a plurality of electronic devices, at least one signal input port and at least one signal output port. The control circuit is installed in the board member and electrically connected with the at least one signal input port and the at least one signal output port for converting a first format of an external signal being inputted into one signal input port into a second format for output through one corresponding signal output port. When one connection interface of the electronic apparatus failed or damaged, it is not necessary to replace the motherboard, and the adapter board assembly can be installed in one slot of the motherboard of the electronic apparatus for expansion application, saving much labor and time and relatively reducing the maintenance cost.

According to another aspect of the present invention, the board member comprises a plug portion extending from a first peripheral side thereof for insertion into one slot of the motherboard of the electronic apparatus, and a metal frame fixedly provided at a second peripheral side thereof and affixed to a rack of the electronic apparatus to hold the board member firmly in place. Therefore, the adapter board assembly will not fall out of the slot of the motherboard upon an accidental vibration of the electronic apparatus.

### BRIEF DESCRIPTION OF THE DRAWINGS

FIG. 1 is an exploded view of the preferred embodiment of the present invention.

FIG. 2 is an assembly view of FIG. 1.

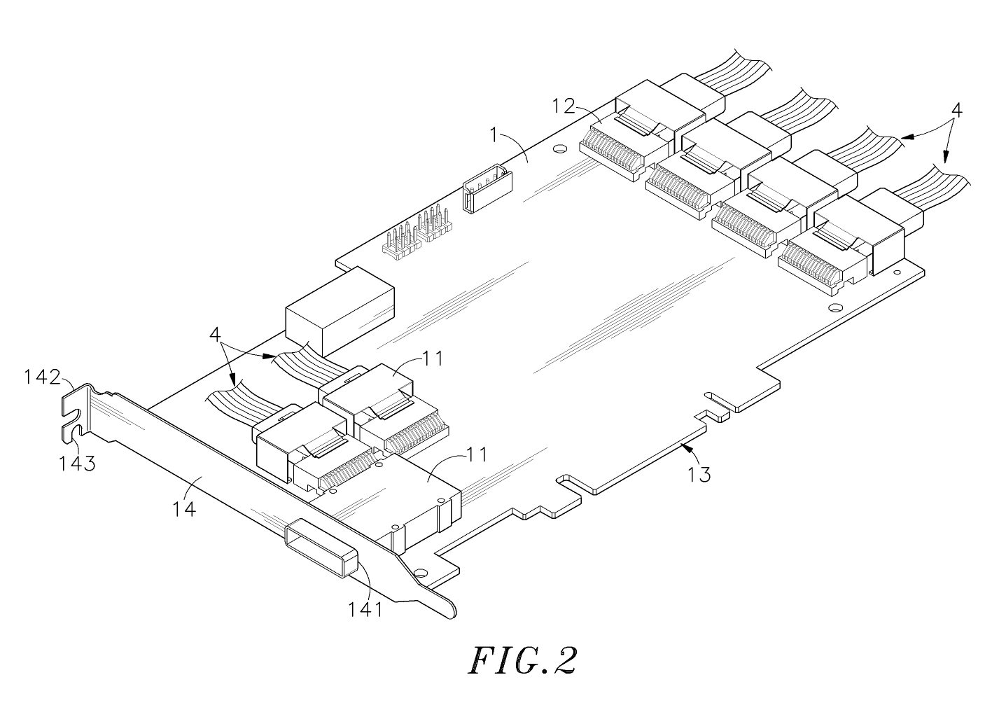

FIG. 3 illustrates an application example of the preferred embodiment before installation.

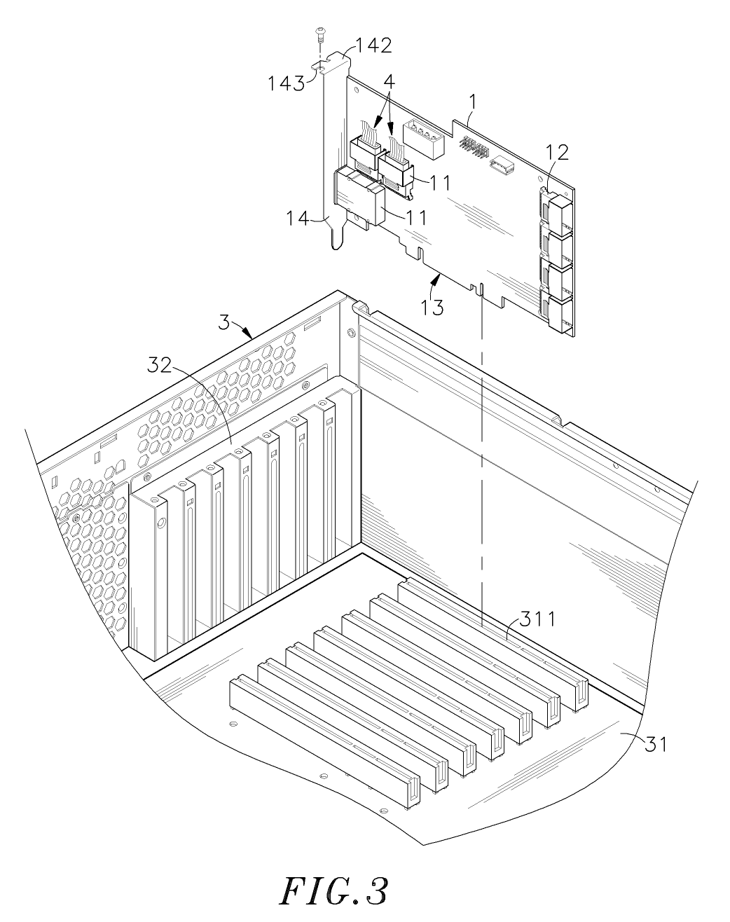

FIG. 4 corresponds to FIG. 3, showing the adapter board assembly installed in the electronic apparatus.

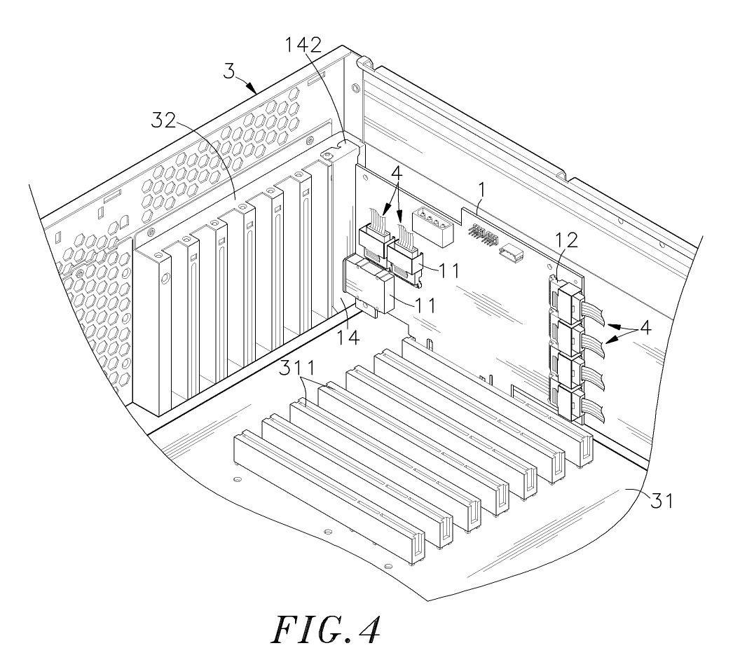

FIG. 5 is a system block diagram of the adapter board assembly according to the preferred embodiment of the present invention.

### DETAILED DESCRIPTION OF THE PREFERRED EMBODIMENT

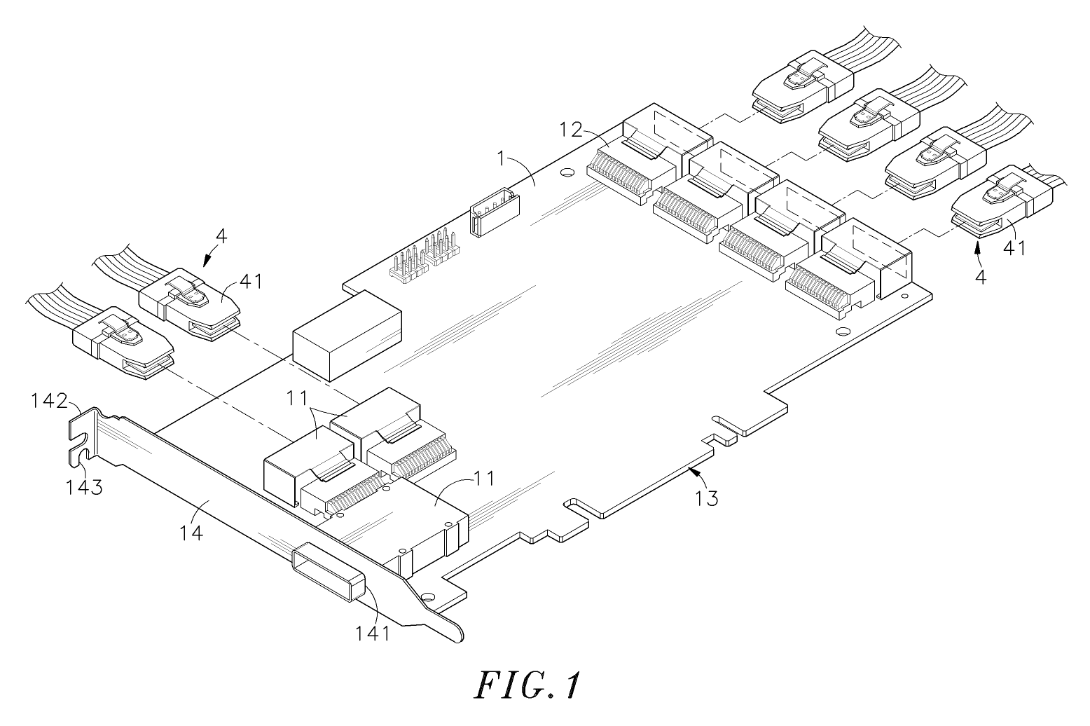

Referring to FIGS. 1˜4, an adapter board assembly in accordance with the present invention is shown comprising a board member 1 and a control circuit 2.

The board member 1 is a printed circuit board having arranged thereon multiple electronic devices. The control circuit 2 is installed in the board member 1. Further, the plate member 1 comprises at least one signal input port 11 and at least one signal output port 12 disposed at the top wall thereof, a plug portion 13 extending from one peripheral side thereof, a metal frame 14 fixedly provided at another peripheral side thereof. The metal frame 14 is a substantially L-shaped metal plate member, having at least one insertion hole 141 cut through the metal frame 14 thereof for the insertion of one respective signal input port 11 and a locating end piece 142 turned from one end of the metal body 14 at an angle. The locating end piece 142 has a mounting notch 143 for the mounting of a fastening member.

The control circuit 2 is electrically connected with the at least one signal input port 11 and the at least one signal output port 12 of the board member 1 for processing each external signal inputted into the at least one signal input port 11 and then outputting each processed signal to one associating signal output port 12.

During installation of the adapter board assembly, the plug portion 13 of the board member 1 is inserted into one slot 311 of the motherboard 31 of an electronic apparatus 3 to have the metal frame 14 be attached to a rack 32 inside the electronic apparatus 3, and then a fastening member (not shown) is inserted through the mounting notch 143 of the locating end piece 142 and fastened to the rack 32 to affix the locating end piece 142 to the rack 32. This installation procedure is quite simple. After installation, the adapter board assembly is firmly secured in place, and the board member 1 is prohibited from falling out of the slot 311 of the motherboard 31 upon an accidental vibration, assuring signal transmission stability.

Further, the signal input ports 11 are provided for the connection of respective matching electrical connectors 41 of transmission lines 4 that transmit external signals to the control circuit 2 through the associating signal input ports 11 of the board member 1 for conversion by the control circuit 2, enabling converted signals to be outputted through the associating signal output ports 12 of the board member 1. The signal output ports 12 are for the connection of respective matching electrical connector 41 of transmission lines 4 for output of converted signals to respective external devices (not shown).

Further, the signal input ports 11 and the signal output ports 12 of the board member 1 can be SAS or Mini SAS sockets, and the electrical connectors 41 of the transmission lines 4 can be SAS or Mini SAS plugs respectively electrically connectable to the SAS or Mini SAS socket type signal input ports 11 and signal output ports 12 of the board member 1. The plug portion 13 of the board member 1 can be a plug design of ISA (industry standard architecture), PCI (peripheral component interconnect), PCI-X (peripheral component interconnect extended) or PCI-Ex (peripheral component interconnect express) standard to match the ISA, PCI, PCI-X or PCI-Ex standard of the slots 311 of the motherboard 31.

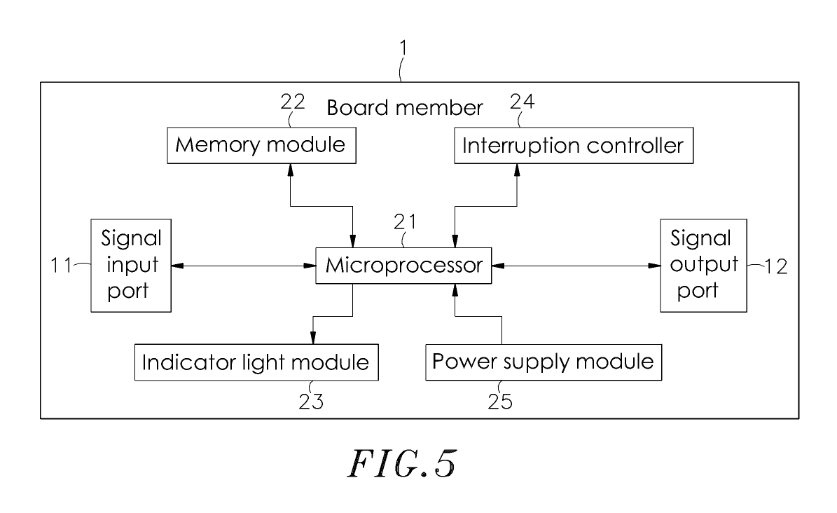

Referring to FIG. 5, the control circuit 2 carried on the board member 1 comprises a microprocessor 21 electrically connected with the signal input ports 11 and the signal output ports 12 for converting each inputted parallel signal into a serial signal for output, a memory module 22 electrically connected with the microprocessor 21 for allowing the microprocessor 21 to store instructions and data temporarily, an indicator light module 23, which is comprised of activity LEDs, fault LEDs and status LEDs, and electrically connected to the GPIO (general purpose I/O) of the microprocessor 21 for indicating the operation status of the signal input ports 11 and the signal output ports 12, an interruption controller 24 electrically connected with the microprocessor 21 for controlling the microprocessor 21 to interrupt the indicator light module 23, and a power supply module 25 electrically connected to the microprocessor 21 to provide the control circuit 2 with the necessary working voltage.

Further, the microprocessor 21 can be an ARM Advanced Risc Machines) microprocessor. The memory module 22 can be RAM, ROM, EEPROM, SRAM or flash memory. Further, the electronic apparatus 3 can be a personal computer, industrial computer or server in which the board member 1 is installable.

In general, the adapter board assembly of the present invention has the following features and advantages:

1. The board member 1 comprises at least one signal input port 11 and at least one signal output port 12 for the connection of respective matching electrical connectors 41 of transmission lines 4, and the signal transmission speed of each signal output port 12 can be as high as 3 Gbs/sec, so that the data storage and reading speed matches the processing speed of the CPU of the electronic apparatus 3, achieving optimal performance.

2. The adapter board assembly is compatible to the slots 311 of a commercial motherboard 31 for electronic apparatus 3 (personal computer, industrial computer or server). By means of the use of the adapter board assembly, the user can expand his (her) electronic apparatus 3 economically without changing the motherboard.

3. It is easy to mount the adapter board assembly. When one connection interface of the electronic apparatus 3 failed or damaged, the adapter board assembly can be installed in one slot 311 of the motherboard 31 of the electronic apparatus 3 for expansion application, saving much labor and time and relatively reducing the maintenance cost.

4. By means of attaching the metal frame 14 of the board member 1 to the rack 32 inside the electronic apparatus 3 and then inserting a fastening member through the mounting notch 143 of the locating end piece 142 and fastening the fastening member to the rack 32 to affix the locating end piece 142 to the rack 32, the adapter board assembly is firmly secured to the respective slot 311 of the motherboard 31 of the electronic apparatus 3 so that accidental vibration of the electronic apparatus 3 does not cause the adapter board assembly to fall out of the slot 311 of the motherboard 31, assuring signal transmission stability.

5. The adapter board assembly can easily and detachably be mounted in one slot 311 of the motherboard 3 of the electronic apparatus 3 for expansion purpose. In addition to the feature of simple structure, the adapter board assembly allows easy mounting and dismounting.

Although a particular embodiment of the invention has been described in detail for purposes of illustration, various modifications and enhancements may be made without departing from the spirit and scope of the invention.

What the invention claimed is:

1. An adapter board assembly used as an interface card in an electronic apparatus for system expansion, comprising:
a board member installed in one slot of a motherboard of said electronic apparatus, said board member being a circuit board having arranged thereon a plurality of electronic devices, said board member comprising at least one signal input port and at least one signal output port; and
a control circuit installed in said board member and electrically connected with said at least one signal input port and said at least one signal output port for converting a first format of an external signal being inputted into one said at least one signal input port into a second format for output through one said at least one signal output port.

2. The adapter board assembly as claimed in claim 1, wherein said board member comprises a plug portion extending from a first peripheral side thereof for insertion into said slot of said motherboard of said electronic apparatus, and a metal frame fixedly provided at a second peripheral side thereof and affixed to a rack of said electronic apparatus, said metal frame having at least one insertion hole cut for the insertion of said at least one signal input port.

3. The adapter board assembly as claimed in claim 2, wherein said metal frame has a locating end piece extending from one end thereof at an angle, said locating end piece having a mounting notch for the mounting of a fastening member to affix said locating end piece to said rack of said electronic apparatus.

4. The adapter board assembly as claimed in claim 2, wherein said plug portion of said board member is a plug design of one of the architectures of ISA (industry standard architecture), PCI (peripheral component interconnect), PCI-X (peripheral component interconnect extended) and PCI-Ex (peripheral component interconnect express) standards, matching the architecture standard of said slot of said motherboard.

5. The adapter board assembly as claimed in claim 1, wherein said at least one signal input port and said at least one signal output port are SAS sockets.

6. The adapter board assembly as claimed in claim 1, wherein said at least one signal input port and said at least one signal output port are Mini SAS sockets.

7. The adapter board assembly as claimed in claim 1, wherein said at least one signal input port is provided for the connection of a matching electrical connector of a transmission line that transmit said first format of said external signal to said control circuit through said at least one signal input port for conversion by said control circuit, and said at least one signal output port is for the connection of a matching electrical connector of a transmission line for output of said second format of said external signal.

8. The adapter board assembly as claimed in claim 7, wherein said electrical connector of said transmission line is a SAS plug.

9. The adapter board assembly as claimed in claim 7, wherein said electrical connector of said transmission line is a Mini SAS plug.

10. The adapter board assembly as claimed in claim 1, wherein said control circuit comprises a microprocessor electrically connected with said at least one signal input port and said at least one signal output port and adapted for converting external parallel signals being inputted through said at least one signal input port into serial signals for output through said at least one signal output port, a memory module electrically connected to said microprocessor and controllable by said microprocessor to store instructions and data temporarily, and an indicator light module electrically connected to said microprocessor for indicating the operation status of said at least one signal input port and said at least one signal output ports.

11. The adapter board assembly as claimed in claim 10, wherein said microprocessor is an ARM (Advanced RISC Machines) microprocessor.

12. The adapter board assembly as claimed in claim 1, wherein said memory module is selected from the group of RAM, ROM, EEPROM, SRAM and Flash memory.

13. The adapter board assembly as claimed in claim 1, wherein said indicator light module is comprised of activity LEDs, fault LEDs and status LEDs.

14. The adapter board assembly as claimed in claim 10, wherein said control circuit further comprising an interruption controller electrically connected with said microprocessor for controlling said microprocessor to interrupt said indicator light module that is electrically connected to the GPIO (general purpose I/O) of said microprocessor.

15. The adapter board assembly as claimed in claim 10, wherein said control circuit further comprises a power supply module electrically connected to said microprocessor to provide the control circuit with the necessary working voltage.

16. The adapter board assembly as claimed in claim 1, wherein said electronic apparatus is a personal computer.

17. The adapter board assembly as claimed in claim 1, wherein said electronic apparatus is an industrial computer.

18. The adapter board assembly as claimed in claim 1, wherein said electronic apparatus is a server.
